(19) United States
(12) Patent Application Publication
(10) Pub. No.: US 2016/0265505 A1
(43) Pub. Date: Sep. 15, 2016

(54) A DEVICE, SYSTEM AND METHOD FOR RECIRCULATION OF WATER AND ENERGY GENERATION

(71) Applicant: BAMYAN TECHNOLOGIES LLC, Wilmington, DE (US)

(72) Inventor: Reza JAHANGIR, Kabul (AF)

(21) Appl. No.: 15/030,168

(22) PCT Filed: Oct. 14, 2014
(86) PCT No.: PCT/US14/60396

§ 371 Date: Apr. 18, 2016

(30) Foreign Application Priority Data
Nov. 7, 2013 (IN) 3286/DEL/2013

(51) Int. Cl. F03B 13/06; F01D 15/10; H02K 7/18; F04F 3/00

(52) U.S. Cl. CPC F03B 13/06; F04F 3/00; F01D 15/10; H02K 7/1823; Y10S 415/916; F03B 17/005

(57) ABSTRACT

A device, system, and method for recirculation of water and energy generation comprises a reservoir and a device that facilitates water flow from the reservoir. The system is used to implement a method for energy generation. The device is configured to minimize friction by utilizing hydrophobic coatings on the inner walls of the device. One-way valves prevent water that has entered the device from going back onto the water reservoirs. Hydrophilic and hydrophobic interactions are further utilized to maintain the water flow. The system then generates a circulating water fall that is used to drive an electrical generator or similar device, such as turbines and dynamos, to generate electricity.

### BACKGROUND OF THE INVENTION

1. Field of the Invention

The present invention relates to the field of energy generation. More specifically, the invention relates to a device, system, and method for generating electricity utilizing fluid mechanics and capillary action.

2. Description of the Background

Water circulation systems typically rely on electrical pumps to ensure water moves from one reservoir to another or out of the reservoir and back onto it. Due to atmospheric pressure and water friction, such pumps must operate continually. It is difficult to overcome gravity in order to have water rise in a vertical column. Gravity and atmospheric pressure further impede such water flow in the absence of mechanical and electrical pumping action.

The latest advances in in the field of liquid and water-repellency such as SLIPS (slippery liquid-infused porous surfaces), as described in International Patent Publication Number: WO2012/100100A2 published on Jul. 26, 2012, and which his incorporated herein by reference in its entirety, have provided new avenues to develop capillary inducement mechanisms and low friction fluid systems. Lower friction alone, however, is not sufficient to overcome gravitational and atmospheric forces in water circulation systems.

In the field of energy generation, solar cell efficiencies are measured under standard test conditions (STC) unless stated otherwise. STC specifies a temperature of 25° C. and an irradiance of 1000 W/m2 with an air mass 1.5 (AM1.5) spectrums. These conditions correspond to a clear day with sunlight incident upon a sun-facing 37°-tilted surface with the sun at an angle of 41.81° above the horizon. This represents solar noon near the spring and autumn equinoxes in the continental United States with surface of the cell aimed directly at the sun. Under these test conditions a solar cell of 20% efficiency with a 100 cm² (10 cm)² surface area would produce 2.0 W. The efficiency of the solar cells used in a photovoltaic system, in combination with latitude and climate, determines the annual energy output of the system. For example, a solar panel with 20% efficiency and an area of 1 m² will produce 200 W at STC, but it can produce more when the sun is high in the sky and will produce less in cloudy conditions and when the sun is low in the sky. There is a need for a more efficient system that is not dependent on solar energy.

### SUMMARY OF THE INVENTION

It is one object to provide a device for circulating water that comprises a flow maintenance section. The flow maintenance section comprises a hydrophobic section and a hydrophilic section and maintains a flow of water that enters the flow maintenance section at a first flow maintenance section end and exits at a second flow maintenance section end.

It is another object to provide a device for circulating water that comprises a vertical section, a transition section, and a discharge section. The transition section connects the vertical section and the discharge section. The vertical section, transition section, and discharge section have an internal wall coated with friction reduction material. The vertical section comprises an intake on a first end and said intake comprises a first one-way valve; said vertical section is connected to the transition section at a second end of the vertical section. The transition section is connected to the vertical section on a first transition section end and to the discharge section on a second transition section end. The discharge section comprises a second one-way valve at a top end of the discharge section, a third one-way valve at a second discharge section end, and a flow maintenance mechanism.

A system for generating electricity that comprising a device for circulating water as described above, a water reservoir, and a hydroelectric generator. The water is collected from the reservoir through the device for circulating water through an intake and discharged at a second flow maintenance section end onto the hydroelectric generator, thus generating electricity.

### BRIEF DESCRIPTION OF THE DRAWINGS

The numerous advantages of the present invention may be better understood by those skilled in the art by reference to the accompanying figures in which:

FIG. 1 is a graphical depiction of a system for circulating water.

FIG. 2 is a graphical representation of the discharge section of one embodiment.

FIG. 3A is a graphical representation of a capillary tube in accordance with a preferred embodiment.

FIG. 3B is a graphical representation of a capillary tube in accordance with one embodiment of the present application.

FIG. 4A is a graphical representation of a capillary plate.

FIG. 4B is a graphical representation of a holder frame and capillary plate.

FIG. 4C is a graphical representation of a holder frame and multiple capillary plates.

FIG. 5 is a graphical representation of a capillary plate and tube showing the boundaries between hydrophobic and hydrophilic sections.

FIG. 6 is a graphical representation of a temperature control device.

FIG. 7 is a graphical representation of a device having a tapered vertical section.

FIG. 8 is a graphical representation of a device having multiple plates with varying hole diameter.

FIG. 9 shows a device for recirculating water with a vertical section in which the diameter decreases from a first end to the transition section.

FIG. 10 shows one application of the recirculating water system where multiple devices and reservoirs are staggered.

### DETAILED DESCRIPTION

The following description is of a particular embodiment of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

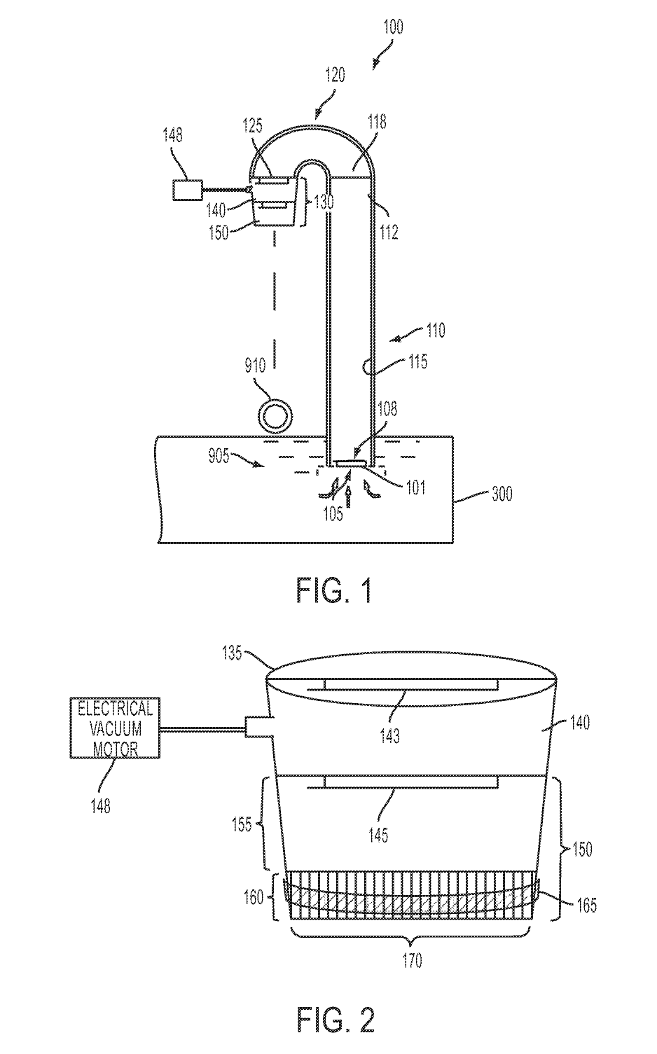

As shown on FIG. 1, a device for circulating water 100 comprises a vertical section 110, a transition section 120, and a discharge section 130. The transition section 120 connects the vertical section 110 and the discharge section 130. In a preferred embodiment, the height of the device 100 is equal or less than 10.33 meters when the reservoir is placed at sea level. The height is measured from the surface of the water on which the device is placed to the highest point on the transition section 120. Maintaining the height below 10.33 meters facilitates circulation of water. Atmospheric pressure is equal to 760 mmHg or 10.33 meters H₂O at sea level. The atmospheric pressure decreases as altitude increases. Thus, at sea level for example, atmospheric pressure on a standard day is 101.3 kPa, while at an elevation of 3,000 meters, the atmospheric pressure on a standard day is about 70 kPa. As a result, the height of the device 100 must be decreased by about 1 meter for each 1,000 meters in altitude at which the device 100 is utilized. In maintaining the height below 10.33 meters, the weight of air on the reservoir in which the device may be placed would assist the movement of water upwards on the vertical section 110 once a vacuum is created as described in more detail below.

A person of ordinary skill in the art would recognize that the approximate height of the device 100 in relation to the atmospheric pressure need not be exact. In other preferred embodiments, the height of the device 100 may be calculated in the following way. In a first step the atmospheric pressure is at a given altitude is identified:

P=101325(1−2.25577 10⁻⁵ h)^{5.5588}

Where P is the air pressure (pa) and h is the altitude above sea level (m). For example, at an elevation of 3,000 m, P is 70.2 kPa. Based on that atmospheric pressure one can calculate the altitude in meters of water where 101.3 kPa is equal to 10.3 m H₂O and, thus, lkPa equals 101.97 mmH₂O. Then, since the P at 3,000 m is 70.2 kPa, the height of the column is calculated by multiplying 101.97 mmH₂O times 70.2 kPa, which is 7.1 mH₂O.

The vertical section 110 has a first end 101 and a second end 112. The first end 101 provides an intake 105 for collecting water. In one preferred embodiment, the intake 105 has a first one-way valve 108. The first one-way valve 108 is configured to allow flow of water only in one direction from the first end 101 towards the second end 112. In a preferred embodiment, the second end 112 of the vertical section 110 is connected to a first transition end 118 of the transition section 120. It is contemplated that, in some embodiments, the vertical section 110 and the transition section 120 are made as a single manufactured piece. In such embodiments, the first transition end 118 and the second end 112 are areas of their respective sections, but do not form a separate structure. In other embodiments, however, the device 100 may comprise a separate vertical section 110 and a separate transition 120 where the second end 112 and the first transition end 118 couple together.

In a preferred embodiment, the vertical section 110 has an internal wall 115. The internal wall 115 may be coated with friction reduction material. The friction reduction material used may be a super slippery and ultra-repellency material made of slippery liquid-infused porous surface (SLIPS) as described in WO2012/100100A2 (the '100 application, incorporated herein by reference in its entirety). As described in the '100 application, the internal wall 115 may be coated by wicking a chemically-inert, high density liquid coating over a roughened solid surface featuring micro and nanoscale topographies. The hydrophobic properties of the SLIPS coatings assist in maintaining the flow of water from the first end 101 towards the second end 112 of the vertical section 110. In other embodiments, it is contemplated that the SLIPS coating is applied to an internal wall of the transition section 120, the internal wall of discharge section 130, or both. In some preferred embodiments, the SLIPS or other hydrophobic coatings can be applied to all the internal walls of the various components of the device 100.

The transition section 120 provides a mechanism to change the direction of the flow of water in the device 100. In one preferred embodiment, the transition section 120 has an upside-down “U” shape. Water enters through the first transition end 118 and exits this section through a second transition end 125. When the device is placed on a water reservoir 300, the vertical section 110 extends in a generally perpendicular direction in relation to the surface of the water. The transition section 120 connects to the vertical section 110 such that the second transition end 125 directs the flow of water towards the water reservoir 300. In one exemplary embodiment, the flow of water exiting the second transition end 125 is parallel to the flow of water up the vertical section 110. It is contemplated that the water may be discharged from the discharge section 130 in a direction that is not substantially parallel to the vertical flow of water, although in some embodiments, it is contemplated that such flow may be parallel to the vertical flow.

The second transition end 125 is then connected to a top end 135 of the discharge section 130. The discharge section 130 has two functions: 1) initiate flow of water from the reservoir 300 and 2) maintain flow of water out of the device 100. In order to achieve these functions, the discharge section 130 is divided into two subsections: flow initiation section 140 and a flow maintenance section 150.

As shown in more detail on FIG. 2, in one preferred embodiment, the flow initiation section 140 has a second one-way valve 143 located at the top end 135 of the discharge section 130 where the top end 135 connects with the second transition end 125. This second one-way valve 143 prevents water from returning to the water reservoir 300 once a flow has been established. A third one-way valve 145 is located between the flow initiation section 140 and the flow maintenance section 150. In order to initiate flow, a vacuum mechanism is installed in the flow initiation section 140. In one exemplary embodiment, one or more efficiency electrical vacuuming motor 148 may be used. The motor is configured to remove air from the flow initiation section 140. A vacuum is created that maintains the third one-way valve 145 closed, opens the second one-way valve 143, and the first one-way valve 108. As a result of the low pressure in the system, the water from the reservoir 300 raises and enters the flow initiation section 140. It is contemplated that other methods of initiating flow to the flow initiation section 140 of the device 100 may be utilized.

The flow maintenance section 150 includes an attachment section 155 and a flow inducement section 160. In some embodiments, these two sections are formed of a single manufacture. In other embodiments these two sections are detachable. The attachment section 155 connects the flow maintenance section 150 to the flow initiation section 140 of the device 100. It allows water to be available for the flow inducement section 160 for maintaining flow of water once it begins. The flow maintenance section 150 comprises a hydrophobic section 306 and a hydrophilic section 305, wherein the flow maintenance section 150 maintains a flow of water that enters the flow maintenance section 150 at a first flow maintenance section end and exits at a second flow maintenance section end.

In one embodiment, the flow inducement section 160 has a holder or supportive frame 165 that provides support for a plurality of capillaries 170. The capillaries 170 are tubes designed to initiate/induce and maintain flow of water. It is contemplated that in some embodiments, the supportive frame or holder 165 provides support for other types of flow inducement components as described in more detail below. In some preferred embodiments the supportive frame or holder 165 is a separate component that can be attached to the attachment section 155.

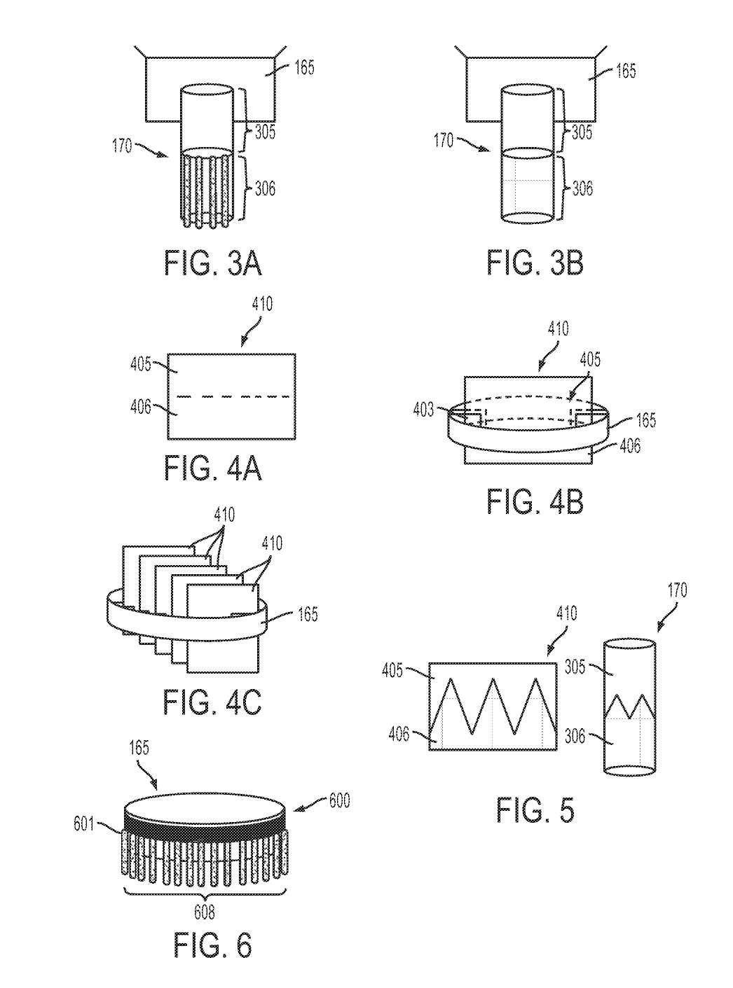

FIG. 3A shows one embodiment that uses capillary tubes 170. The capillary tubes 170 have two discrete sections: a hydrophilic section 305 and a hydrophobic section 306. In some embodiments that capillary tubes have a plurality of alternating hydrophobic sections 306 and hydrophilic sections 305. The hydrophilic section 305 has a water contact angle that is smaller than the water contact angle of the hydrophobic section 306. In one alternative embodiment, the capillary tubes have a hydrophilic section 305 and the section 306, and in this section 306, they have a plurality of alternating hydrophilic portions of higher and lower surface tension. In one example, alternating glass portions between yarn parts which extend the capillary tubes a little as shown in FIG. 3A.

The definitions of surface tension and surface energy involve consideration of behavior of liquids in contact with solids and the formation of droplets or thin films. One convenient way of qualifying this behavior is to measure the angle θ formed by the liquid-solid and the liquid-liquid interfaces. If θ is greater than 90° the liquid tends to form droplets on the surface. If θ is less than 90° the liquid tends to spread out over the surface. When θ is zero, the liquid tends to form a thin film on the surface. In addition, the surface tension of the water in the hydrophilic section 305 is smaller than the surface tension of the water in the hydrophobic section 306. In one alternative embodiment shown in FIG. 3B, the hydrophobic sections 306 of the capillary derive their hydrophobic properties from coatings of SLIPS as described above for the vertical section 110 of the device 100. The water contact angle of the rough surface of the hydrophilic section 305 is less than 90°. The water contact angle on the slippery-hydrophobic surfaces would be greater than 90°. The contact angle for SLIPS it varies depending on the type of material being used. The contact angles of various materials are shown, for example, in U.S. Patent Publication Number 2014/0187666 (the “666 Application”) (incorporated herein by reference in its entirety). For example, when Silanized Epoxy resin (S.Epoxy) is used, the contact angle is about 113° where about means±2.8; where the solid surface is Epoxy, the water contact angle is about 92.6° where about means±1.8; and where the solid surface is silicon, the water contact angle about 13.1° where about means±1.7. As described herein, the device can be made of many different materials and a person of ordinary skill in the art would be able to ascertain the appropriate contact angle.

As explained in the '666 Application, an equilibrium contact angle, θ, is the angle at which a liquid/vapor interface meets a solid surface, which is determined by the interactions across the three interfaces, e.g., solid/liquid/vapor. Experimentally, the most stable equilibrium contact angle of a liquid droplet on a real surface can be difficult to attain. Liquid droplets sitting on the surface exhibit a variety of contact angles bound by two extreme values. The upper limit is known as the apparent advancing contact angle θ_{adv} whereas the lower limit is referred as the apparent receding contact angle θ_{rec}. The difference between these values is known as contact angle hysteresis (i.e., Δθ=θ_{adv}−θ_{rec}, where θ_{adv}≧θ≧), which characterizes the liquid repellency of a surface. For example, contact angle hysteresis less than about 5°, 2.5°, 2° or even less than 1° can be obtained. Low contact angle hysteresis encourages sliding at low tilt angle (e.g. <5°). Conventionally, equilibrium contact angle can be roughly estimated by the average of the advancing and receding angles (i.e., θ=(θ_{adv}+θ_{rec})/2) or by a static contact angle, θ_{static} (i.e. θ=θ_{static}).

FIG. 4A shows an alternative embodiment capillary plate 410 that may be used instead of capillary tube 170. As utilized in this application, the term “capillary plate” refers to a flat surface (as opposed to a cylindrical tube) of any size that is used to create a liquid flow. In a capillary tube, the height of upward flow of water is inversely proportional to the capillary tube's diameter. According to the formula below, also to calculate how high the water will go inside the capillary tube, the Formula is used as below:

$$h = \frac{2 γ cos θ}{ρ Rg} = \frac{2 ( 72.8 dyne \text{/} cm ) ( 1 )}{( 1 gr \text{/} {cm}^{3} ) ( R in cm ) ( 980 cm \text{/} {s}^{2} )}$$

where: h is the height of water rise inside the tube (from the reservoir level in which the tube is placed); γ is the surface tension; θ is the contact angle of the liquid on the tube surface; ρ is the density of the liquid; R is the radius of the tube; g is the acceleration due to gravity. For example, the height of the water inside a tube with 1 mm diameter (or 0.5 mm radius) will be about 3 cm (2.97 cm) and for a tube with 1 cm diameter (or 5 mm radius), the height of the water will be about 3 mm (0.29 cm).

Similarly, as described below, the upward flow when utilizing plates is inversely proportional to the distance between two capillary plates. The capillary plate 410, as the capillary tube 170, has a hydrophilic section 405 and a hydrophobic section 406. The height of the water pulled up inside the capillary tube is reversely proportional to the diameter of the tube, as discussed above. Similarly, the height of water up between two capillary plates 410 is inversely proportional to the distance between the capillary plates 410. The distance water will travel between two capillary plates 410 can be calculated utilizing the following formula:

$$h = \frac{2 γ}{ρ dg} = \frac{2 ( 72.8 dyne \text{/} cm )}{( 1 g \text{/} {cm}^{3} ) ( d ) ( 980 cm \text{/} {s}^{2} )}$$

In the formula, d is the distance between the plates in cm. For example, if the distance is 0.5 mm the height of water will be about 3 cm (2.97 cm) and if it is 1 mm, the height will be about 1.5 cm (1.48 cm).

FIG. 4B shows a capillary plate 410 installed on in a holder or frame 165 (described above). The holder or frame 165 has guides 430 for each capillary plate 410. FIG. 4C shows an alternative embodiment having multiple capillary plates 410 housed in the holder or frame 165. It is contemplated that, in one preferred embodiment, instead of having capillary plates with hydrophobic sections 406 and hydrophilic sections 405, the holder or frame 165 holds capillary plates 410 that are entirely hydrophobic 406 or entirely hydrophilic 405. In such instance, the hydrophobic plates and hydrophilic plates alternate creating the desired flow due to their hydroscopic qualities.

The capillary plates 410 are arranged in close proximity to each other to create a capillary bridge that causes the water to be pulled down away from the attachment section 155. In on possible arrangement the plates 410 of the same size are arranged in such a way that the hydrophobic and hydrophilic sections alternate. In an alternative embodiment, plates 410 that are either hydrophobic or hydrophilic are arranged so that the hydrophilic plates 410 sit higher than the hydrophobic plates and maintain the flow of water in the same direction. In yet a further embodiment, the plates are made of different sizes so that the hydrophilic plates extend above the hydrophobic plates promoting the flow of water. One advantage of the use of plates in contrast to tubes is that they are cheaper and easier to manufacture.

As shown in FIG. 5, the capillary plate 410 or capillary tube 170 can be further engineered to have the most efficient hydrophilic 305, 405 or hydrophobic 306, 406 sections. In one preferred embodiment, the hydroscopic sections are divided as shown in the figure where a “W” pattern allows for a close interaction between hydrophobic and hydrophilic sections of each component, whether a plate 410 or a tube 170. This optimal interaction in one preferred embodiment maximizes the surface area between the hydrophobic and hydrophilic sections of the plate 410 or tube 170. It is contemplated that each section can be manufactured separately and then joint together for use.

In some preferred embodiments, as shown on FIG. 6, a temperature control device 600 may be utilized to avoid overheating of the capillary tubes 170. In some environments, the combination of the ambient temperature, water temperature, and the motion of the water through the capillary tubes 170, may result in temperatures in the range of 40 to 50° C. or above. In such instances, water surface tension is affected considerably and the efficiency of the capillary tubes 170 is reduced. In one preferred embodiment, this issue is addressed by including a temperature control device 600 as shown in FIG. 6. The temperature control device 600 consists of a sleeve 601 and extensions 608. The sleeve 601 fits around the holder or frame 165 of the capillary tubes 170. The extensions 608 extend beyond the end of the flow inducement section 160 and the holder or frame 165. The extensions 608 are further configured to be in the stream of water being discharged from the inducement section 160. The temperature control device is manufactured from a porous material, such as a sponge, that absorbs water. The extensions 608 collect small amounts of water as it flows out of the device 100 until the entire sleeve 601 is wet. The wet sleeve 601 provides a cooling mechanism for the capillary tubes 170. As energy in the form of heat is absorbed by the water in the sleeve 601, the water evaporates and the capillary tubes 170 are cooled.

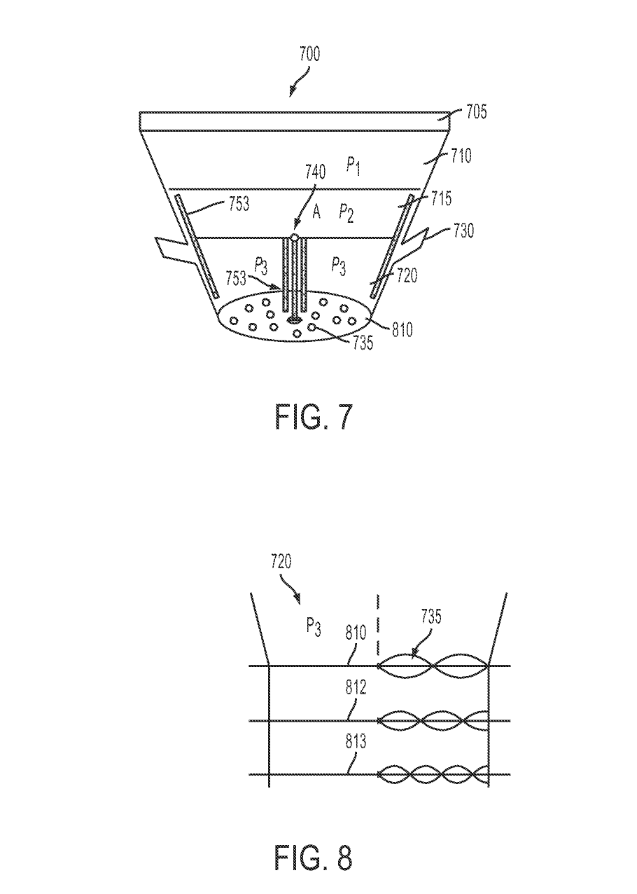

In one alternative embodiment, an attachment device 700, as shown in FIG. 7, is connected to the attachment section 155 of the flow maintenance section 150, or in other words, it is replaced by the inducement section 160 of the flow maintenance section 150. The attachment device 700 has several sections: a connecting section 705, a first flow section P₁ 710, a second flow section P₂ 715, a third flow section P₃ 720, one or more vents or adjustable openings 730, and discharge holes 735. In one embodiment, the attachment device 700 is permanently connected to the attachment section 155 of the flow maintenance section 150. In another preferred embodiment, the attachment device 700 is detachably attached to the attachment section 155. In such embodiment, the attachment device's 700 connecting section 705 may be threaded and can be screwed into matching threads at the attachment section 155.

The attachment device 700 has a first flow section P₁ 710 and a second flow section P₂ 715, where the first flow section P₁ 710 has a greater diameter than that of the second flow section P₂ 715. As a result, there is a smaller volume of water in the second flow section P₂ 715 that results in decreased pressure and increased speed of the water in the second flow section P₂ 715. At point A 740, the attachment device 700 is divided by a dividing wall 743 to create a third flow section P₃ 720. The third flow section P₃ 720, thus, provides a smaller space available to the flowing water because the water is now moving into two sides of the dividing wall 743, each with smaller diameter than the second flow section P₂ 715. The decrease in volume results in an increase in the speed of the water moving through the device.

At third flow section P₃ 720, in some embodiments, one or more vents or adjustable openings 730. In addition, small discharge holes 735 are placed at the bottom of the third flow section P₃ 720 on a fixed discharge plate 810. When the one or more vents or adjustable openings 730 are open, the atmospheric pressure overcomes the surface tension of the water at the small discharge holes 735, which allows the water to flow. If the one or more vents or adjustable openings 730 are closed, the surface tension of the water at the small discharge holes 735 is greater than the force of gravity alone pulling on the water and, thus, the water does not flow. In one preferred embodiment, the small discharge holes 735 have a diameter of between 2 and 10 mm, preferably between 4 and 6 mm, or more preferably about 5 mm. The diameter of the holes can vary and may be adjustable. For example, the sizes could be changed by including two plates having the same hole configuration that rest one on top of the other and can be turn in reference to each other. When the plates are in the open position the holes in both plates are aligned and provide the maximum diameter for the channel that allows water to pass through. When one of the plates is allowed to turn, while the other is maintained stationary, the holes are no longer aligned and the diameter of the channel will be the difference between the offset of the two holes. In other embodiments, removable plates 801, 804 can be used as shown in FIG. 8. Where each removable plate 812, 813, has discharge holes of smaller diameter than the plurality of the discharge holes 735.

In a preferred embodiment, the attachment device 700 has an dividing wall 753 that extends from the second flow section P₂ 715 through the third flow section P₃ 720 that is coated with or made from hydrophobic materials, preferably SLIPS material, assisting in promoting the movement of the water from the connecting section 705 to the discharge holes 735. Other hydrophobic materials can be utilized to coat the dividing wall 753 so as to cause a turbulent current at the second flow section P₂ 715 and the third flow section P₃ 720.

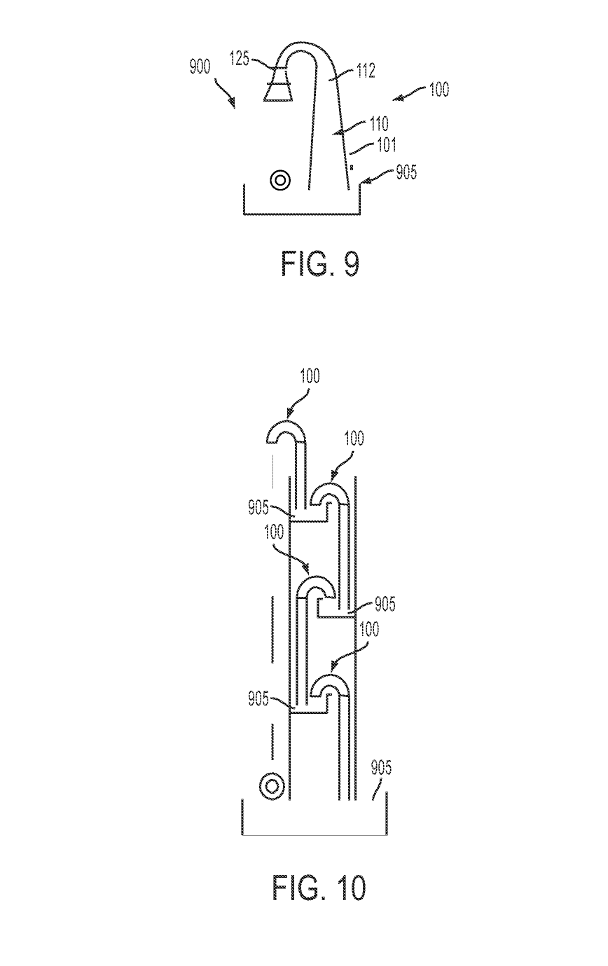

In an alternative embodiment, as shown in FIG. 9, the vertical section 110 is designed in such a way that the first end 101 of the vertical section 110 has a larger diameter than the second end of the vertical section 112. As a result, the space available to the water as it travels upwards is reduced and thus the volume of water is reduced unless the speed of the water increases. In such embodiment, the transition section 120 has the small diameter. In some embodiments the second transition end 125 may have a larger diameter, which allows the water to slow down after it passes through the apex of the transition section. In these types of embodiments, the discharge section 130 is still the same.

The device 100 described above can be utilized for many different applications. In one preferred embodiment the device 100 is used in a recirculating water system 900. The system has two components: the device 100 and a water reservoir 300. A method for recirculating water can be implemented utilizing the system 900. In a first step of the method, a vacuum is generated by the electrical motors 148. The vacuum pulls water from the reservoir up through the vertical section 110 and the transition section 120 and onto the discharge section 130. Once the flow of water is generated, the electrical motors 148 are turned off and the discharge section 130 ensures that the flow of water continues. The water replenishes the reservoir 300 and the process continues. Some examples of possible applications include aquariums, where the reservoir 300 is the aquarium; ornamental pools, fountains, and other similar constructions.

In an alternative embodiment, multiple devices 100 can be utilized as shown on FIG. 10. In one preferred embodiment, multiple recirculating water systems 900 can be linked together in a staggered fashion. In this embodiments, the water reservoir 300 are placed at different heights. It is contemplated that each recirculating water system 900 is linked to the next. The device 100 of each water system 900 has a different height depending on the altitude at which the water reservoir 300 is located. As a general rule, for every 100 meters increase in altitude for the reservoir 300, there is a pressure decrease of 1.2 kPa. In order to account for such a change, the height of the device above the surface of the water will be adjusted.

In yet a further embodiment, a recirculating water system 900 can be utilized for generating electricity as shown on FIG. 1. The system 900 has three primary components: a water reservoir 300, the device 100, and a hydroelectric power generator 910. The hydroelectric generator 910 is placed below the discharge section 130 and is situated such that water that exits the discharge section 130 actuates the hydroelectric generator 910 creating an electrical current for distribution.

A method for producing energy can be implemented utilizing the system 900. In a first step of the method, a vacuum is generated by the electrical motors 148. The vacuum pulls water from the reservoir up through the vertical section 110 and the transition section 120 and onto the discharge section 130. Once the flow initiation section 140 of the discharge section 130 is filled with the water, the electrical vacuum motor 148 is turned off automatically, and as it is turned off, it triggers the one-way valve 145 of the discharge section 130 to be opened and to fill the attachment section 155 that then due to capillary action of capillary tubes 170, the water flow is induced and maintained and the discharge section 130 ensures that the flow of water continues. In a second step of the method, the water that exits actuates the hydroelectric generator 910. After the water actuates the hydroelectric generators 910, it returns to the water reservoir 905. The water replenishes the reservoir 300 and the process continues.

In yet further embodiments, the device for circulating water may also be utilized to create water dispensing system from a river or other body of water. The device can be placed in an unlimited resource of water such as a river. The device could transfer water to desired heights and distances as shown in FIG. 10. It could be used for many different applications, such irrigation or simply moving a desired amount or water from one place to another. In some preferred embodiments, various filtering mechanisms can be placed before the intake of the device providing filtered water. Filtering assists in the efficiency of the system, as water impurities are kept out of the device.

The system described above overcomes most of the challenges that current green technologies are facing as for example the conditions on which solar and wind technologies depend. The least efficiency of the concept is about 2.5 kw/m², in other words, an area of its inducement section of about 1 m² will produce 2500 W. The amount of energy (i.e., potential energy), which is converted to kinetic energy through the device, results in the least power (in watts) that can be obtained from the device and is calculated as follows:

$${Power}_{( Watt )} = \frac{m . g . h}{t} = \frac{\begin{matrix}water mass ( or volume ) . \\ ( 9.8 \text{/} m ) . height ( of the device ) in m\end{matrix}}{{s}^{2}}$$

The total produced energy (mechanical energy) could be calculated as follows:

$${E}_{mechanical} = m ( g . h + \frac{{v}^{2}}{2} ) = ( water mass or volume ) [ ( 9.8 m \text{/} {s}^{2} ) ( height of the device in m ) + \frac{{( total velocity induced by the device )}^{2}}{2} ]$$

And at least by changing two primary variables; the volume or water (through desired quantity m² of inducement plates) and the height of the device, the desired amount of energy could be obtained.
As indicated above, the preferable conditions are sea level atmospheric pressure with the height of the device of about 10 meters

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

### INDUSTRIAL APPLICABILITY

The present invention is applicable to the generation of water flow circulation. The invention discloses a device and method for generating and maintaining a flow of water. The method can be practiced in industry in the field of water flow and energy generation.

What is claimed is:

1. A device for circulating water, comprising:
a flow maintenance section that comprises a hydrophobic section and a hydrophilic section, wherein the flow maintenance section maintains a flow of water that enters the flow maintenance section at a first flow maintenance section end and exits at a second flow maintenance section end.

2. The device of claim 1, wherein the water flow maintenance section is attached to a discharge section that comprises a flow initiation section.

3. The device of claim 2, wherein the device further comprises a transition section connected to said discharge section.

4. The device of claim 3, wherein the device for circulating water comprises a vertical section connected to said transition section that allows vertically flow of water from a reservoir.

5. The device of claim 2, further comprising a first one-way valve on a first end of said vertical section.

6. The device of claim 2, further comprising a second one-way valve on a top end of the discharge section.

7. The device of claim 2, third one-way valve is located between the flow initiation section and the flow maintenance section.

8. The device of claim 4, wherein the vertical section has an internal wall coated with a friction reduction material.

9. The device of claim 8, wherein the friction reduction material is a slippery liquid-infused porous surface (SLIPS).

10. The device of claim 1, wherein the hydrophobic section and the hydrophilic section are sections of a capillary tube.

11. The device of claim 10, wherein the flow maintenance section comprises a plurality of capillary tubes.

12. The device of claim 1, wherein the hydrophilic section has a smaller contact angle than the hydrophobic section.

13. The device of claim 12, wherein the contact angle of hydrophobic section is about 113° if the device is manufactured from S. Epoxy; about 92.6° if the device is manufactured from Epoxy; or 13.1° if the device is manufactured from silicon.

14. The device of claim 1, wherein the hydrophobic section and the hydrophilic section are sections of a capillary plate.

15. The device of claim 14, wherein the flow maintenance section comprises a plurality of parallel capillary plates.

16. The device of claim 15, wherein the parallel capillary plates alternate between hydrophilic and hydrophobic capillary plates.

17. The device of claim 16, wherein the parallel capillary plates are spaced apart a sufficient distance from each other to pull down the water between them, wherein the distance between each plate is preferably 1 mm.

18. The device of claim 1, having a height that is equal or less than 10.33 meters.

19. The device of claim 2, wherein the flow initiation section comprises a vacuum mechanism.

20. The device of claim 19, wherein the vacuum mechanism is an electrical vacuuming motor.

21. The device of claim 1, further comprising a temperature control device.

22. The device of claim 1, further comprising a first flow section having a greater diameter than a second flow section, a third flow section of smaller diameter than the second flow section and having a dividing wall.

24. The device of claim 22, wherein said dividing wall is coated with hydrophobic materials, preferably SLIPS.

25. The device of claim 22, further comprising a fixed discharge plate comprising plurality of discharge holes.

26. The device of claim 25, wherein said discharge holes have a variable diameter.

27. The device of claim 25, wherein said discharge holes have a diameter of between 2 and 10 mm, preferably between 4 and 6 mm, or more preferably about 5 mm.

28. The device of claim 25 further comprising one or more removable plates, wherein each of said removable plates has discharge holes of smaller diameter than the plurality of discharge wholes.

29. A system for generating electricity, comprising a device for circulating water in accordance with claim 1, a water reservoir, and a hydroelectric generator; wherein water is collected from the reservoir through the device for circulating water through an intake, and discharged at a second flow maintenance section end onto the hydroelectric generator.

30. A device for circulating water, comprising:
a vertical section, a transition section, and a discharge section, wherein the transition section connects the vertical section and the discharge section; and wherein
the vertical section, transition section, and discharge section have an internal wall coated with friction reduction material;
and wherein said vertical section comprises an intake on a first end and said intake comprises a first one-way valve; said vertical section is connected to the transition section at a second end of the vertical section;
the transition section is connected to the vertical section on a first transition section end and to the discharge section on a second transition section end; and
said discharge section comprises a second one-way valve at a top end of the discharge section, a third one-way valve at a second discharge section end, and a flow maintenance mechanism.

31. The device of claim 30, wherein the discharge section further comprises a vacuum generating device.

32. The device of claim 30, wherein said maintenance mechanism comprises a plurality of capillary tubes.

33. The device of claim 32, wherein each of the capillary tubes comprise a hydrophobic section and a hydrophilic section.

34. The device of claim 30, wherein the friction reduction material is a slippery liquid-infused porous surface (SLIPS).
